(19) United States
(12) Patent Application Publication
(10) Pub. No.: US 2025/0224718 A1
(43) Pub. Date: Jul. 10, 2025

(54) ABNORMALITY DIAGNOSIS METHOD, ABNORMALITY DIAGNOSIS APPARATUS, NON-TRANSITORY COMPUTER-READABLE MEDIUM STORING ABNORMALITY DIAGNOSIS PROGRAM, AND ABNORMALITY DIAGNOSIS SYSTEM

(71) Applicant: Mitsubishi Electric Corporation, Tokyo (JP)

(72) Inventors: Misa NOZUKI, Chiyoda-ku, Tokyo (JP); Shinsuke MIKI, Chiyoda-ku, Tokyo (JP)

(73) Assignee: Mitsubishi Electric Corporation, Tokyo (JP)

(21) Appl. No.: 18/854,558

(22) PCT Filed: Apr. 25, 2022
(86) PCT No.: PCT/JP2022/018740

§ 371 Date: Oct. 7, 2024

(51) Int. Cl. G05B 23/02

(52) U.S. Cl. CPC G05B 23/024

(57) ABSTRACT

A method of diagnosing whether there is abnormality includes obtaining data having a quantity of state of one or more assessment items from the facility, classifying, for each operation state of the facility, data obtained from the facility, assessing sufficiency of the number of pieces of data for each classified data group, calculating multiple parameter values configuring a trained model in accordance with the sufficiency and holding the parameter values in association with the operation state, obtaining the parameter values configuring the trained model without overlaps for each parameter, in accordance with the operation state of data to be diagnosed and a status of holding of the parameter values associated with each operation state, creating the trained model to diagnose data, with the parameter values, calculating a degree of abnormality for determination as to abnormality based on the trained model, and determining whether or not there is the abnormality.

### TECHNICAL FIELD

The present disclosure relates to an abnormality diagnosis method, an abnormality diagnosis apparatus, and an abnormality diagnosis program.

### BACKGROUND ART

Monitoring of a state and diagnosis of abnormality, of a facility or a device are generally performed based on data having a quantity of state of a single assessment item or a plurality of assessment items obtained from a diagnosis target. This data having the quantity of state of the assessment item(s) includes various types of operation data of the facility or the device to be diagnosed and measurement data on a temperature, vibration, and others generated from the diagnosis target and measured with various sensors. These operation data and measurement data are time-series data obtained by continuous observation of change over time.

In one approach to abnormality diagnosis, a trained model is created, with time-series data (normal data) obtained during normal operations among pieces of thus obtained time-series data being used as training data, and whether or not there is abnormality in the facility or the device is determined based on data to be diagnosed and the trained model. In such abnormality diagnosis, in an example where there is change in time-series data not derived from abnormality, such as change after maintenance or change because of change in operation mode, when the facility or the device is diagnosed based on the trained model obtained with the use of the training data obtained before maintenance or before change in operation mode, such normal change in state is erroneously determined as abnormality. Therefore, a method of diagnosing the facility or the device without erroneous determination when there is such normal change in operation state has been demanded.

Japanese Patent Laying-Open No. 2017-102826 (PTL 1) discloses a technique “to enable highly accurate abnormality diagnosis in accordance with change in status of a mechanical system” (see “Subject” in “Abstract”). According to this technique, “in abnormality diagnosis with the use of a pattern recognition approach for diagnosis target data, training data to be used for training information is extracted for each piece of diagnosis target data based on the diagnosis target data and extraction condition information for determination of an extraction condition held by a training information creator 11, and thereafter the training information in accordance with the training data is created and abnormality diagnosis is conducted” (see “Solving Means” in “Abstract”).

Japanese Patent Laying-Open No. 2014-32657 (PTL 2) discloses “a method of monitoring a facility state with a high-sensitivity and high-speed abnormality sensing method and an apparatus therefor” (see paragraph 0009). According to this method, a method of “storing a cluster center and data belonging to a cluster by clustering of training data in advance, selecting data close to new observation data from the training data belonging to the cluster close to the new observation data, creating a normal model from this selected data, and calculating an abnormal measure” is disclosed (see “Abstract”).

Japanese Patent Laying-Open No. 2015-181072 (PTL 3) discloses a technique “in a method of monitoring a state of a facility based on a time-series signal outputted from the facility, to provide an operation pattern label every certain period based on the time-series signal, to select training data based on the operation pattern label every certain period, to create a normal model based on this selected training data, to calculate an abnormal measure based on the time-series signal and the normal model, and to identify whether the state of the facility is abnormal or normal based on this calculated abnormal measure” (see “Abstract”). It further describes a method based on a macro feature value (an average, a variance, a maximum value, a minimum value, or the like) as a method of searching for an operation patter label close in state.

### CITATION LIST

### Patent Literature

PTL 1: Japanese Patent Laying-Open No. 2017-102826
PTL 2: Japanese Patent Laying-Open No. 2014-32657
PTL 3: Japanese Patent Laying-Open No. 2015-181072

### SUMMARY OF INVENTION

### Technical Problem

Some facilities to be diagnosed operate only in some operation states determined in advance and other facilities to be diagnosed operate based on an optimal operation state determined each time in accordance with a peripheral device or an environment. For the latter, it is difficult to define in advance, the number of operation states the facility can be in or a state thereof. In an example where diagnosis is conducted with the use of a trained model created from training data determined based on a condition (an extraction condition or a cluster) for classification of data to be diagnosed for each operation state as in the technique disclosed in PTL 1 or PTL 2, when diagnosis target data which does not satisfy the condition for classification created in advance is inputted, training data cannot appropriately be selected and determination as to abnormality may be erroneous. In order to conduct appropriate diagnosis of such diagnosis target data, training data the same in operation state as the diagnosis target data should newly be collected, and disadvantageously, diagnosis cannot be conducted until the data is collected.

In order to address such a problem, according to the technique disclosed in PTL 3, the macro feature value is used as the method of searching for an operation patter label close in operation state, operation state data similar in macro feature value is selected as training data, a threshold value for individual determination as to abnormality is set for the selected training data, and the facility is diagnosed.

According to this technique, even when the state of the facility changes, training data similar in state can be selected to create the trained model, so that diagnosis can be conducted. On the other hand, for data to be diagnosed, a series of processes including selection of training data, creation of a trained model, and determination of a threshold value for determination as to abnormality is required, which increases an amount of calculation for these processes. The threshold value for determination as to abnormality should appropriately be set in accordance with similarity between the training data and the diagnosis target data. PTL. 3, however, is silent about a specific method as to how to determine an abnormality determination threshold value for diagnosis with the trained model created from the training data determined based on the macro feature value. If setting of the threshold value for determination as to abnormality is erroneous, abnormality determination may be erroneous.

A technique is required to diagnose whether or not there is abnormality in a diagnosis target facility without erroneous determination as abnormality, of change in time-series data with change in state of the facility even when there is change in time-series data with change in state of the facility not caused by abnormality, such as change after maintenance or change because of change in operation mode. In addition, a technique to reduce an amount of calculation necessary for these processes is required.

The present disclosure was made in view of backgrounds as described above, and discloses a technique to improve accuracy in determination as to abnormality to essentially be detected without erroneous determination of change in time-series data as abnormality even when there is change in time-series data not derived from abnormality, such as change after maintenance or change because of change in operation mode. The present disclosure further discloses a technique to reduce a period of collection of training data necessary for diagnosis and to conduct diagnosis without erroneous determination even when change in operation state of the facility is not predictable in advance. Furthermore, the present disclosure discloses a technique to reduce an amount of calculation necessary for these processes.

### Solution to Problem

According to one form of the present disclosure, an abnormality diagnosis method of diagnosing whether there is abnormality in a facility to be diagnosed is provided. This abnormality diagnosis method includes obtaining from the facility, data having a quantity of state of a single assessment item or a plurality of assessment items, classifying for each operation state of the facility, the data obtained from the facility, assessing sufficiency of the number of pieces of data for each classified data group, calculating a plurality of parameter values configuring a trained model in accordance with the sufficiency of the number of pieces of data and holding the parameter values in association with the operation state, obtaining the plurality of parameter values configuring the trained model without overlaps for each parameter, in accordance with the operation state of the data to be diagnosed and a status of holding of the parameter values associated with each operation state, creating a trained model to diagnose data to be diagnosed, with the obtained parameter values, calculating a degree of abnormality for determination as to abnormality based on the trained model, and determining whether there is abnormality in a diagnosis target based on the degree of abnormality.

According to another embodiment, an abnormality diagnosis apparatus to diagnose whether there is abnormality in a facility to be diagnosed is provided. This abnormality diagnosis apparatus includes a data reader to obtain from the facility, data having a quantity of state of a single assessment item or a plurality of assessment items, a data classifier to classify for each operation state of the facility, the data obtained from the facility, a parameter calculator and holder to assess sufficiency of the number of pieces of data for each classified data group, to calculate a plurality of parameter values configuring a trained model in accordance with the sufficiency of the number of pieces of data, and to hold the parameter values in association with the operation state, a parameter obtaining unit to obtain the plurality of parameter values configuring the trained model without overlaps for each parameter, in accordance with the operation state of the data to be diagnosed and a status of holding of the parameter values associated with each operation state, a trained model creator to create a trained model to diagnose the data to be diagnosed, with the obtained parameter values, an abnormality degree calculator to calculate a degree of abnormality for determination as to abnormality based on the trained model, and an abnormality determination unit to determine, based on the degree of abnormality, whether there is abnormality in a diagnosis target.

According to another embodiment, an abnormality diagnosis program to cause a computer to perform processing for diagnosing whether there is abnormality in a facility to be diagnosed is provided. This abnormality diagnosis program causes the computer to perform obtaining from the facility, data having a quantity of state of a single assessment item or a plurality of assessment items, classifying for each operation state of the facility, the data obtained from the facility, assessing sufficiency of the number of pieces of data for each classified data group, calculating a plurality of parameter values configuring a trained model in accordance with the sufficiency of the number of pieces of data and holding the parameter values in association with the operation state, obtaining the plurality of parameter values configuring the trained model without overlaps for each parameter, in accordance with the operation state of the data to be diagnosed and a status of holding of the parameter values associated with each operation state, creating a trained model to diagnose the data to be diagnosed, with the obtained parameter values, calculating a degree of abnormality for determination as to abnormality based on the trained model, and determining whether there is abnormality in a diagnosis target based on the degree of abnormality.

According to yet another embodiment, an abnormality diagnosis system to diagnose whether there is abnormality in a facility to be diagnosed is provided. This abnormality diagnosis system includes a data reader to obtain from the facility, data having a quantity of state of a single assessment item or a plurality of assessment items, a data classifier to classify for each operation state of the facility, the data obtained from the facility, a parameter calculator and holder to assess sufficiency of the number of pieces of data for each classified data group, to calculate a plurality of parameter values configuring a trained model in accordance with the sufficiency of the number of pieces of data, and to hold the parameter values in association with the operation state, a parameter obtaining unit to obtain the plurality of parameter values configuring the trained model without overlaps for each parameter, in accordance with the operation state of the data to be diagnosed and a status of holding of the parameter values associated with each operation state, a trained model creator to create a trained model to diagnose the data to be diagnosed, with the obtained parameter values, an abnormality degree calculator to calculate a degree of abnormality for determination as to abnormality based on the trained model, and an abnormality determination unit to determine whether there is abnormality in a diagnosis target based on the degree of abnormality.

### Advantageous Effects of Invention

According to the present disclosure, normal change in operation state because of maintenance or change in operation mode is not erroneously determined and accuracy in diagnosis can be improved. Even when change in operation state of the facility is not predictable in advance, a period for newly collecting training data necessary for diagnosis can be reduced and diagnosis without erroneous determination can be conducted. In addition, an amount of calculation necessary for these calculation processes can be reduced.

The foregoing and other objects, features, aspects and advantages of this invention will become more apparent from the following detailed description of this invention when taken in conjunction with the accompanying drawings.

### BRIEF DESCRIPTION OF DRAWINGS

FIG. 1 is a block diagram showing a functional configuration of an abnormality diagnosis apparatus 100.

FIG. 2 is a diagram exemplifying a method of classification into an operation state based on processing in a data classifier 104 for determining whether or not there is change in time-series data on at least one assessment item.

FIG. 3 is a flowchart showing a part of processing performed by a parameter calculator and holder 105.

FIG. 4 is a flowchart showing a part of processing performed for processing for obtaining a parameter in a parameter obtaining unit 106.

FIG. 5 is a diagram showing an exemplary hardware configuration of a computer system 500 activated as abnormality diagnosis apparatus 100.

FIG. 6 is a flowchart showing a part of processing performed by computer system 500 implementing abnormality diagnosis apparatus 100 according to a second embodiment.

### DESCRIPTION OF EMBODIMENTS

An embodiment of the present invention will be described below with reference to the drawings. In the description below, the same components have the same reference characters allotted and their labels and functions are also the same. Therefore, detailed description thereof will not be repeated.

### First Embodiment

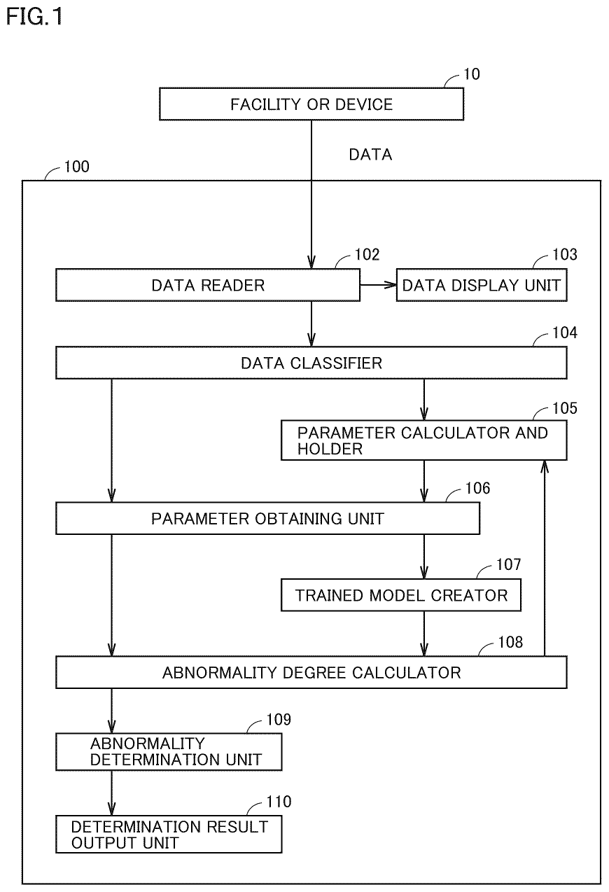

A configuration of an abnormality diagnosis apparatus 100 according to one embodiment will be described with reference to FIG. 1. FIG. 1 is a block diagram showing a functional configuration of abnormality diagnosis apparatus 100 to implement an abnormality diagnosis method of the present invention. Abnormality diagnosis apparatus 100 determines whether or not a state of a facility or a device to be diagnosed (which may also collectively be expressed as a “facility” below) is normal by analyzing time-series data obtained from the facility. In addition, abnormality diagnosis apparatus 100 is configured to output a result of that determination.

The facility or the device to be diagnosed is, for example, an apparatus or a plant such as a generator, a factory automation (FA) device, a power reception and distribution device, an elevator, and an electric device for railways. Examples of the plant include a power generation plant, a water treatment plant, and an industrial plant for petrochemicals, metal, and food and drug. Depending on a type of the plant, the plant is composed of a plurality of facilities or devices. A single facility or device may be diagnosed as set forth above, or the facility or the device may be composed of a plurality of facilities or devices as in the case of the plant. A configuration in an example where abnormality diagnosis apparatus 100 is applied to monitoring of a state and diagnosis of abnormality of a generator will be exemplified below.

As shown in FIG. 1, abnormality diagnosis apparatus 100 includes a data reader 102, a data display unit 103, a data classifier 104, a parameter calculator and holder 105, a parameter obtaining unit 106, a trained model creator 107, an abnormality degree calculator 108, an abnormality determination unit 109, and a determination result output unit 110. Abnormality diagnosis apparatus 100 accepts input of data obtained from a facility or device 10.

### [Data Reading]

Data reader 102 reads time-series data obtained from the facility to be diagnosed. The time-series data is obtained by continuous observation of change over time in quantity of state of a single assessment item or a plurality of assessment items. The time-series data may be any of data outputted from the facility and data outputted from a sensor (not shown) provided in the facility. Description in the case of the generator will be given. Assessment items include assessment items relating to operation data such as output, a rotation speed, a voltage, or an armature current of the generator and assessment items relating to measurement data obtained by measurement of a temperature and vibration measured by the sensor attached to a device or a component included in the generator. The assessment items may include assessment items relating to an environment where the generator is provided, such as an outside air temperature as well as operation data and measurement data of the facility relating to the operation state of the generator. The assessment item may be composed of a single assessment item or a plurality of assessment items, and the quantity of state of the assessment item represents a physical quantity obtained in a time series manner as data from each assessment item. These assessment items are by way of example, and the number of items is not limited. The time-series data may include time stamp information. When the time-series data on a plurality of assessment items is obtained, cycles of data measurement (sampling) desirably coincide between/among the assessment items. When the cycles do not coincide, by performing such processing as leaving out or interpolating data on at least one assessment item after the data is obtained, such a form as allocation of quantities of state of the plurality of assessment items to one time (sampling) is set. Data reader 102 transmits read data to data display unit 103 and data classifier 104.

### [Data Representation]

Data display unit 103 shows data received from data reader 102, in a graph as the time-series data. In one aspect, data display unit 103 may show each piece of data in a time-series manner in accordance with time or timing specified by the time stamp. Data display unit 103 may be implemented as a monitor apparatus contained in a computer system or an external monitor apparatus connected to the computer system.

### [Data Classification]

Data classifier 104 classifies data received by data reader 102, for each operation state. The operation state represents the operation state of a facility to be diagnosed. The quantity of state of the time-series data obtained from a diagnosis target changes with change in operation condition of the facility or change in control of the facility. The operation state is defined as being different between before and after this change, and data before the change and data after the change are classified. In other words, data classifier 104 classifies the obtained data for each similar operation state (quantity of state). Not only with change in operation condition or control but also with shutdown or maintenance of the facility, the state of the facility may change and the quantity of state of the obtained time-series data may change. These changes are also to be classified. The number of operation states classification into which is to be made is not limited, and the number is determined in accordance with characteristics of a diagnosis target facility or change in quantity of state of data during a period during which the facility being in a normal operation state has already been known. Classification into the operation state is made such that one operation state is allocated for each time of measurement of data (for each time of sampling), regardless of the number of assessment items of obtained data.

Data classifier 104 classifies data received by data reader 102 for each operation state based on cluster processing or processing for determining whether or not there is change in data on at least one assessment item.

The cluster processing may be a non-hierarchical cluster approach such as k-means or a hierarchical cluster approach. In another aspect, data classifier 104 may learn a classification rule in processing for classification into the operation state, apply the classification rule to data newly received from data reader 102 after learning, and determine the operation state classification into which is to be made. For example, a center of gravity of each cluster can be calculated from data belonging to each cluster determined in the cluster processing, a distance between the center of gravity of each cluster and classification target data can be calculated as a determination index, and the operation state classification into which is to be made can be determined based on a threshold value determined in advance. In another example, data classified into each cluster and the operation state thereof can be associated with each other as training data, and the training data can be applied to machine learning such as support vector machine, random forest, and k-nearest neighbor and deep learning such as a neural network to create a classifier, which can be used to classification into the operation state.

A method of classification into the operation state based on processing for determining whether or not there is change in time-series data on at least one assessment item will now be described.

Data classifier 104 can select any assessment item and determine the operation state into which data is to be classified, based on whether or not a threshold value for the quantity of state set in advance is exceeded. When the threshold value is crossed, the time-series data is determined as having changed, and the operation state of data is distinguished and classified across the threshold value. The number or a value of threshold values for determination can freely be determined.

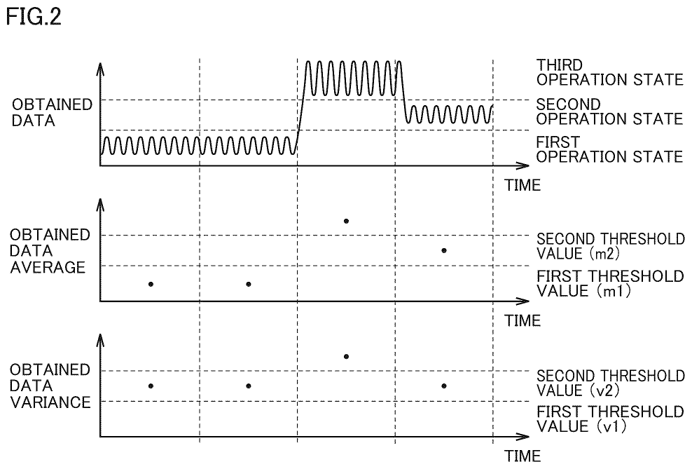

Another example will further be described with reference to FIG. 2. FIG. 2 is a diagram exemplifying a method of classification into an operation state based on processing for determining in the data classifier whether or not there is change in time-series data on at least one assessment item. Data classifier 104 divides the time-series data on the selected assessment item at any temporal widths and calculates a statistic such as an average, a variance, a standard deviation, a maximum, a minimum, a kurtosis, and a skewness for each data group resulting from division. At least one or combination of these statistics is assessed based on a predetermined threshold value for determination. When the threshold value is crossed, the time-series data is determined as having changed and the operation state into which data in a divided range is to be classified is determined. As shown in FIG. 2, the time-series data (obtained data) on any one assessment item is divided at any temporal widths, and an average and a variance are calculated from the divided data group and chronologically arranged. Threshold values (m1 to m2 and v1 to m2) are determined in advance for the average and the variance and the operation state of data in the divided temporal range is determined based on these threshold values. FIG. 2 shows an example of classification into three operation states of first to third operation states based on these threshold values. When the average is smaller than m1 and the variance is within a range not smaller than v1 and smaller than v2, classification as the first operation state is made, when the average is not smaller than m2 and the variance is not smaller than v2, classification as the second operation state is made, and when the average is within a range not smaller than m1 and smaller than m2 and the variance is within a range not smaller than v1 and smaller than v2, classification as the third operation state is made.

At least one assessment item for calculation of the statistic may be set, and an assessment may be made by using a plurality of assessment items. With this method, classification of change in operation state in consideration of variation in data, which is difficult in classification by determination based on the threshold value for the quantity of state, can be made.

In the processing for classifying data based on the cluster processing or the processing for determining whether or not there is change in data on at least one assessment item, the number of operation states classification into which is to be made and various threshold values used as criteria can freely be determined or may be updated after they are set.

When it is clear that data of interest has changed due to maintenance of the facility or change in condition for control of operations of the facility, data classifier 104 may make classification into the operation state at timing of maintenance of the facility or change in condition for control of operations.

### [Calculation and Holding of Parameter Value]

Referring again to FIG. 1, parameter calculator and holder 105 calculates a value of a parameter necessary for creation of a trained model for each data group classified by data classifier 104 and holds the calculated value. According to one embodiment, the trained model refers to a mathematical expression or data processing for calculation of an analysis output value (a degree of abnormality) for making abnormality determination. The parameter means a portion of a constant configuring the trained model (the mathematical expression or the data processing) and refers to a value that changes in accordance with the training data (data used for learning).

In the description below, an example where (a unit space according to) a Mahalanobis-Taguchi method (MT method) is employed as the trained model will be described by way of example. The unit space means a normal data group that serves as the reference for diagnosis. When (the unit space according to) the Mahalanobis-Taguchi (MT) method is employed as the trained model, an average, a standard deviation, and an inverse matrix of a correlation matrix of data defining the unit space are included as parameters necessary for creation of the trained model.

The trained model in the present disclosure is not limited to the MT method, and it is applicable also to a method of using a statistical model, a model for known abnormality diagnosis used in the field of machine learning or deep learning, and a data analysis approach.

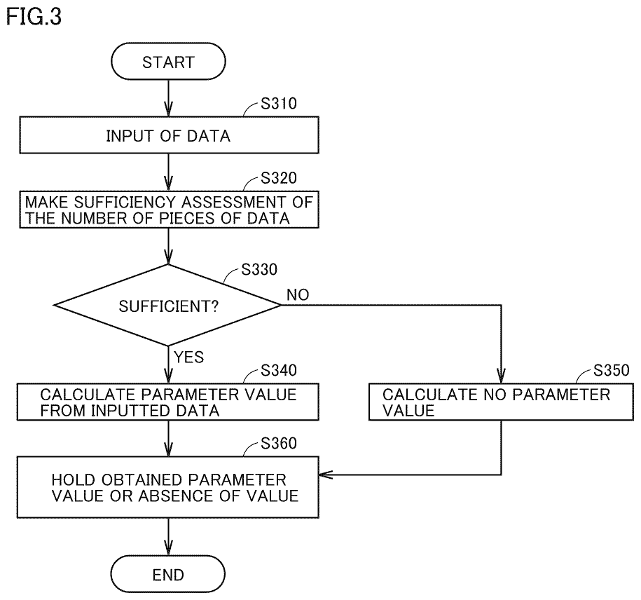

Processing for calculating and holding a value of a parameter will now be described with reference to FIG. 3. FIG. 3 is a flowchart showing a part of processing performed by parameter calculator and holder 105. Processing below is implemented by execution of an instruction for implementing the processing by a CPU with a well-known configuration or another processor. In another aspect, such processing may also be implemented by a circuit element configured to implement the processing.

In step S310, parameter calculator and holder 105 receives input of data classified by data classifier 104.

In step S320, parameter calculator and holder 105 makes a sufficiency assessment of the number of pieces of data for each classified data group. Parameter calculator and holder 105 determines in advance as assessment of sufficiency, the number of pieces of data necessary for calculation of a parameter value that allows diagnosis without erroneous determination, for example, based on past records of diagnosis and creation of a trained model, and assesses the sufficiency based on the number of pieces of data. In other words, whether or not the number of pieces of data in the data group classified into each operation state is equal to or more than the number that allows diagnosis without erroneous determination is determined as assessment of the sufficiency in the present embodiment. Other than this method, parameter calculator and holder 105 can make an assessment of the sufficiency based on a coefficient of correlation between/among a plurality of assessment items or an amount of change in basic statistic (an average, a variance, a maximum value, a minimum value, a kurtosis, or a skewness) of any assessment item. Specifically, parameter calculator and holder 105 initially divides a data group classified into a certain operation state at any temporal ranges (every number of pieces of data), and calculates the coefficient of correlation or the basic statistic of a data group in a smallest divided range oldest in the chronological order. Parameter calculator and holder 105 then calculates the coefficient of correlation or the basic statistic from the data group obtained by combining a data group second oldest in the chronological order and the oldest data group. Parameter calculator and holder 105 further calculates the coefficient of correlation or the basic statistic from a data group obtained by combining a data group third oldest in the chronological order, the second oldest data group, and the oldest data group. Parameter calculator and holder 105 thus adds stepwise, a data group newer in the chronological order to calculate the coefficient of correlation or the basic statistic until calculation for all divided data groups is completed. Parameter calculator and holder 105 calculates the amount of change in coefficient of correlation or basic statistic that is calculated stepwise, and determines the number of pieces of data used for calculation when the amount of change is smaller than the predetermined threshold value, as the number sufficient for calculation of the parameter for diagnosis without erroneous determination. With this method, even when data for training is added, parameter calculator and holder 105 can determine the minimum number of pieces of data beyond which the coefficient of correlation or the basic statistic does not change any more, and can determine the sufficiency assessment as OK when the amount of change is smaller than the predetermined threshold value. Alternatively, parameter calculator and holder 105 may calculate the coefficient of correlation or the basic statistic for each of data groups divided at any temporal ranges (the number of pieces of data), assess variation thereof, and adopt the number of pieces of divided data, variation of which is not larger than the threshold value, as the number of pieces of data determined as OK in sufficiency assessment. When there are a plurality of parameters configuring the trained model, parameter calculator and holder 105 may individually select an assessment method for sufficiency assessment of the number of pieces of data for each parameter and a threshold value thereof from the above, and set them.

In step S330, parameter calculator and holder 105 determines whether or not there are a sufficient number of pieces of data. When parameter calculator and holder 105 determines that there are a sufficient number of pieces of data, that is, when a result of sufficiency assessment of the number of pieces of data indicates OK (YES in step S330), it switches control to step S340. Otherwise, that is, when the result of sufficiency assessment indicates NG (NO in step S330), parameter calculator and holder 105 switches control to step S350.

In step S340, parameter calculator and holder 105 calculates a value of a parameter (which will be referred to as a parameter value in the description below) from data (the classified data group) inputted in step S310.

In step S350, parameter calculator and holder 105 does not calculate the parameter value.

In step S360, parameter calculator and holder 105 holds the calculated parameter value (step S340) in association with the operation state. On the other hand, when parameter calculator and holder 105 does not calculate the parameter value (step S350), it holds absence of the parameter value in association with the operation state.

Similar processing is performed for all parameters configuring the trained model. Parameter calculator and holder 105 performs similar processing for each operation state classification into which is made in data classifier 104, calculates the parameter value configuring the trained model for all operation states, and holds the value or absence of the value in accordance with a result of sufficiency assessment.

The processing for calculating and holding the parameter can be regarded as a part of a step of “learning” to create the trained model for abnormality diagnosis.

### [Obtainment of Parameter Value]

Parameter obtaining unit 106 obtains without overlaps for each parameter, a plurality of parameter values configuring the trained model in accordance with the operation state of data to be diagnosed and a status of holding of the parameter values associated with each operation state. In the present embodiment, the status of holding of the parameter values associated with each operation state refers to a result of processing in parameter calculator and holder 105, and means association of information on the parameter value configuring the trained model or absence of the parameter value for each operation state and a state thereof.

Obtainment of the parameter refers to a part of the step of “learning” to create the trained model for abnormality diagnosis, and can be regarded as a configuration for creation of the trained model suitable for diagnosis of data to be diagnosed without erroneous determination.

Processing for obtaining a parameter value in parameter obtaining unit 106 will now be described.

Initially, a flow until data to be diagnosed reaches parameter obtaining unit 106 will be described with reference to FIG. 1. Data to be diagnosed is read by data reader 102, and then subjected to classification processing in data classifier 104. This processing can be performed based on the classification rule described in the description of the data classifier. Thereafter, processing in parameter obtaining unit 106 is performed.

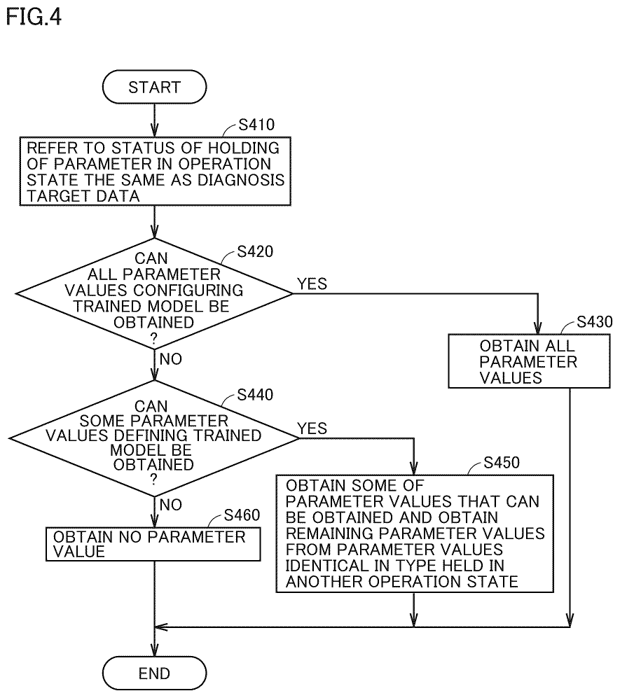

Processing for obtaining the parameter value in parameter obtaining unit 106 will now be described with reference to FIG. 4. FIG. 4 is a flowchart showing a part of processing performed for processing for obtaining a parameter in parameter obtaining unit 106. Processing below is also performed by execution of an instruction for implementing the processing by the CPU with a well-known configuration or another processor. In another aspect, such processing may also be implemented by a circuit element configured to implement the processing.

In step S410, parameter obtaining unit 106 refers to the status of holding of the parameter associated with the operation state the same as the operation state of data to be diagnosed, the operation state being determined in data classifier 104.

In step S420, parameter obtaining unit 106 determines whether or not all parameter values configuring the trained model can be obtained from the operation state that has been referred to. In other words, the parameter obtaining unit determines whether or not all parameter values in the operation state are held in parameter calculator and holder 105 as presence of value. If parameter obtaining unit 106 determines that all parameter values can be obtained (are held as presence of value) (YES in step S420), it switches control to step S430. Otherwise (NO in step S420), parameter obtaining unit 106 switches control to step S440.

In step S430, parameter obtaining unit 106 obtains all parameter values held in the operation state.

In step S440, parameter obtaining unit 106 determines whether or not some of parameter values configuring the trained model can be obtained from the operation state that has been referred to. In other words, the parameter obtaining unit determines whether or not some of parameters in the operation state are held in parameter calculator and holder 105 as presence of value. If parameter obtaining unit 106 determines that some of the parameter values configuring the trained model can be obtained (are held as presence of value) (YES in step S440), it switches control to step

S450. Otherwise (NO in step S440), parameter obtaining unit 106 switches control to step S460.

In step S450, parameter obtaining unit 106 obtains only some of the parameter values that can be obtained and obtains remaining parameter values from parameter values of the identical type held in another operation state.

In step S460, parameter obtaining unit 106 obtains none of parameter values.

Contents of processing by data classifier 104, parameter calculator and holder 105, and parameter obtaining unit 106 will now be described with reference to specific examples below. With data during any already known period during which normal operations of the facility have been confirmed in advance being used as training data, the data is applied to processing for classifying data and calculating and holding parameters. Description will be given assuming that the operation state of the facility is classified into data groups of three operation states A, B, and C as a result of processing in data classifier 104. In addition, an example where unit space information (the average, the standard deviation, and the inverse matrix of the correlation matrix) for conducting abnormality diagnosis by the MT method is created as the trained model will be considered.

In such a case, parameter calculator and holder 105 makes a data sufficiency assessment for calculation of each parameter, for each of operation states A, B, and C.

Consequently, for example, in operation state A, when the result of sufficiency assessment of all parameters indicates OK, in operation state A, parameter calculator and holder 105 calculates an average a, a standard deviation a, and an inverse matrix a of the correlation matrix with the training data classified into operation state A, and holds each calculated value in association with operation state A.

In operation state B, on the other hand, when the result of sufficiency assessment of data only of the inverse matrix of the correlation matrix indicates NG, parameter calculator and holder 105 calculates only an average b and a standard deviation b from the training data classified into operation state B and holds these calculated values in association with operation state B. The inverse matrix of the correlation matrix is held in association with operation state B as absence of value.

In operation state C, when the result of sufficiency assessment of data of all parameters indicates NG, parameter calculator and holder 105 calculates none of parameters from the training data classified into operation state C and holds information indicating absence of value of the parameters in association with operation state C.

Exemplary processing in parameter obtaining unit 106 will now be described. By way or example, an example where data to be diagnosed is inputted to data reader 102 and classified by data classifier 104 and consequently the operation state of the data is determined as operation state A will be described. Parameter obtaining unit 106 obtains a parameter value (the average a, the standard deviation a, and the inverse matrix a of the correlation matrix) held in operation state A which is the operation state the same as diagnosis target data.

An example where the operation state of the diagnosis target data is determined as operation state B will now be described. Parameter obtaining unit 106 obtains the parameter value held in operation state B which is the operation state the same as the diagnosis target data. Since only the average b and the standard deviation b are held as presence of value in operation state B, parameter obtaining unit 106 obtains these values. The value of the inverse matrix of the correlation matrix, on the other hand, is not held in operation state B, and parameter obtaining unit 106 is unable to obtain the value. Parameter obtaining unit 106 then obtains this parameter value that has not yet been obtained from the parameter value held in another operation state (for example, operation state A). Therefore, in operation state B, parameter obtaining unit 106 obtains the average b, the standard deviation b, and the inverse matrix a of the correlation matrix.

When parameter obtaining unit 106 obtains a parameter held in another operation state, it can freely determine which operation state is to be selected. Desirably, however, the parameter value obtained from another operation state is similar between the operation states. For example, when the inverse matrix of the correlation matrix is obtained from another operation state, parameter obtaining unit 106 obtains the parameter value held in the operation state that seems to be high in similarity of correlation between assessment items. A similar way of thinking may also be applied to a parameter of another type. Depending on a type of the trained model or the parameter, such an operation as designating in advance prohibition of diversion of the parameter value in another operation state may be adopted.

Thus, even when some of parameter values held in the operation state the same as the diagnosis target data are not held, by obtaining the calculated and held parameter value from the training data in another operation state, a period for newly collecting training data in the operation state the same as the diagnosis target data (to calculate the parameter) can be reduced. The parameter the value of which is not held (sufficiency assessment of which is NG) requires a larger number of pieces of training data necessary for diagnosis without erroneous determination than another parameter the sufficiency assessment of which is OK, and collection of the training data takes time. Therefore, the period for collection of data for obtaining this parameter value is not necessary, and in correspondence thereto, a period for collection of data before start of diagnosis can be reduced.

Finally, an example where the operation state of the diagnosis target data is determined as operation state C will be considered. Though parameter obtaining unit 106 obtains the parameter value held in operation state C the same as the diagnosis target data, there is no value of the parameter in operation state C and hence parameter obtaining unit 106 obtains none of values of the parameters.

### [Creation of Trained Model]

Trained model creator 107 creates the trained model with the parameter value obtained by parameter obtaining unit 106. As described previously, the MT method or any other abnormality diagnosis approach may be employed as the trained model. In the case of the MT method, the obtained parameter value (the average, the standard deviation, and the inverse matrix of the correlation matrix) is used to define the unit space. When parameter obtaining unit 106 obtains none of the parameter values associated with the operation state the same as the operation state of data to be diagnosed, trained model creator 107 does not create the trained model but temporary puts diagnosis on hold. Putting diagnosis on hold means that subsequent abnormality degree calculation processing in abnormality degree calculator 108 and abnormality determination processing in abnormality determination unit 109 are not temporarily performed. When training data necessary for diagnosis has not sufficiently been collected (sufficiency assessment is NG), abnormality diagnosis apparatus 100 postpones diagnosis to thereby prevent erroneous determination. Furthermore, processing for selecting training data necessary for creation of the trained model for each piece of diagnosis target data as in the conventional technique is not required and the parameter value and the trained model are automatically determined when the operation state of the diagnosis target data is determined. Therefore, a calculation capacity can be reduced.

### [Calculation of Degree of Abnormality]

Abnormality degree calculator 108 calculates the degree of abnormality for determination as to abnormality of the facility based on data to be diagnosed and the trained model created by trained model creator 107. In one example according to one aspect, in the example of the MT method, abnormality degree calculator 108 calculates a Mahalanobis distance as the degree of abnormality, from the data to be diagnosed and the unit space which is the created trained model.

Abnormality determination unit 109 determines whether or not there is abnormality in the facility or the device to be diagnosed based on the degree of abnormality calculated by abnormality degree calculator 108 and a threshold value predetermined for determination as to whether or not there is abnormality.

For example, abnormality determination unit 109 determines a threshold value in advance for the degree of abnormality. When the degree of abnormality is smaller than the threshold value, the abnormality determination unit makes determination as being normal, and when the degree of abnormality is equal to or larger than the threshold value, it makes determination as being abnormal. Parameter calculator and holder 105 is configured to make a sufficiency assessment of the number of pieces of data. Therefore, if parameter obtaining unit 106 can obtain at least one parameter configuring the trained model and diagnosis is conducted, the threshold value for the degree of abnormality for determination as being abnormal can be set to a uniform value. Specifically, the fact that the number of pieces of data is sufficient (the parameter values are held) in sufficiency assessment in parameter calculator and holder 105 means that the parameter values necessary for creation of the trained model with which diagnosis is conducted at certain accuracy can be calculated. Even when training data further increases, the parameter value and accuracy in diagnosis are not varied. Therefore, in diagnosis in which the trained model created from the parameter value calculated from the number of pieces of data assessed as OK in sufficiency assessment is applied, the threshold value for determination as to normality can be set to a constant value. In other words, processing for determining a threshold value for abnormality determination for each piece of diagnosis target data is not necessary, and determination of the diagnosis target data can be made by using a predetermined abnormality determination threshold value corresponding to the operation state.

In the conventional technique, for diagnosis without erroneous determination, processing for individually determining the threshold value for abnormality determination in accordance with the diagnosis target data and the trained model is necessary for individual diagnosis target data. In contrast, in the present invention, whether or not to create the trained model, that is, whether or not to conduct diagnosis, is automatically determined in accordance with the result of sufficiency assessment of the training data in parameter calculator and holder 105 (whether or not the parameter value is held as presence of value) or whether or not parameter obtaining unit 106 can obtain the parameter value. Since abnormality determination unit 109 can determine one value as the threshold value for abnormality determination as described above when diagnosis is conducted, processing for determining the threshold value for abnormality determination for each piece of diagnosis target data is not necessary and an amount of calculation for diagnosis can be reduced.

### [Output of Result of Determination]

Determination result output unit 110 outputs change over time in degree of abnormality calculated by abnormality degree calculator 108 and a result of determination in abnormality determination unit 109. Determination result output unit 110 may transmit these results of determination to a monitor apparatus (not shown) connected to abnormality diagnosis apparatus 100 or an external apparatus (for example, a server computer provided in a central monitoring apparatus) through a communication line (not shown).

### [Hardware Configuration]

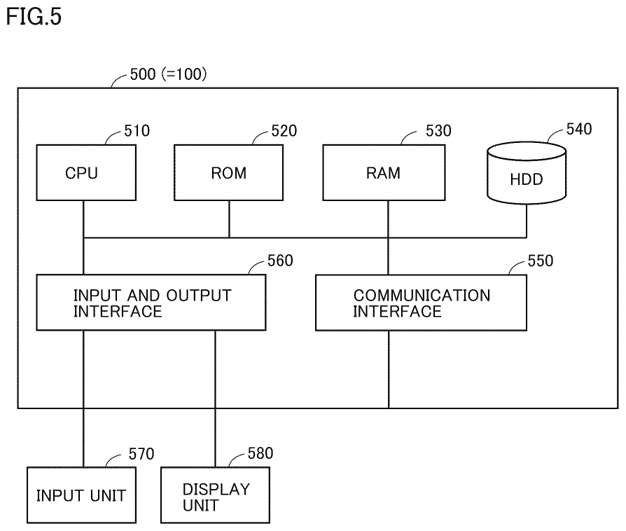

A hardware configuration of abnormality diagnosis apparatus 100 will be described with reference to FIG. 5. FIG. 5 is a diagram showing an exemplary hardware configuration of a computer system 500 activated as abnormality diagnosis apparatus 100.

Computer system 500 includes a central processing unit (CPU) 510, a read only memory (ROM) 520, a random access memory (RAM) 530, a hard disk drive (HDD) 540, a communication interface (I/F) 550, and an input and output (I/O) interface 560. Input and output interface 560 may be connected to an input unit 570 and a display unit 580.

CPU 510 executes each instruction included in a program. When CPU 510 executes the program, processing for implementing the function shown in FIG. 1 is performed in accordance with each instruction.

A program or data prepared in advance is held in ROM 520 permanently (in a non-volatile manner).

Data to be used during execution of the program by CPU 510 is temporarily stored in RAM 530, and RAM 530 functions as a temporary data memory to be used as a work area.

HDD 540 is a non-volatile storage device, and data generated by CPU 510, data received through communication interface 550, or data inputted to input and output interface 560 is held in HDD 540. The non-volatile storage device is not limited to HDD 540, and a semiconductor storage device such as a flash memory may be adopted instead of or in addition to HDD 540.

Communication interface 550 communicates with another apparatus communicatively connected to computer system 500. For example, when computer system 500 is communicatively connected to an external device including a facility to be diagnosed, communication interface 550 as data reader 102 reads (receives) data transmitted from the external device.

I/O interface 560 accepts input of a signal from the external device to computer system 500 or outputs a signal to the external device. The external device may include, for example, a central management apparatus or another server computer, a wirelessly connected smartphone, a tablet terminal, and the like.

Input unit 570 accepts input of an instruction or a signal to computer system 500. In one aspect, input unit 570 is implemented by an input apparatus to accept an operation by a user of computer system 500, such as a keyboard, a mouse, a touch panel, or other devices. In another aspect, input unit 570 may also be implemented as a device that outputs a signal, such as a camera or various sensors.

Display unit 580 implements representation based on a signal inputted from I/O interface 560. Display unit 580 is implemented, for example, by a monitor apparatus, an indicator, a lamp, or the like. In one aspect, display unit 580 corresponds to one example of data display unit 103 and determination result output unit 110. Display unit 580 may show time-series data obtained from the facility or the device to be diagnosed and a result of determination by abnormality determination unit 109 as to whether or not there is abnormality in the facility or the device.

Processing in computer system 500 is implemented by each piece of hardware and software executed by CPU 510. Such software may be stored in advance in HDD 540. Software may be distributed as a program product as being stored in a compact disc-read only memory (CD-ROM) or another storage medium. Alternatively, software may be provided as a program product that can be downloaded by an information provider connected to what is called the Internet. Such software is read from the storage medium by an optical disc drive apparatus (not shown) or another reader or downloaded through communication interface 550, and thereafter once stored in HDD 540. That software is read by CPU 510 from HDD 540 and stored in a form of an executable program in RAM 530. CPU 510 executes the program.

Each constituent element included in computer system 500 shown in FIG. 5 is general. Therefore, an essential part of the present invention may be software stored in ROM 520, RAM 530, HDD 540, or another storage medium or software that can be downloaded through a network. Since operations of each piece of hardware of computer system 500 have been well known, detailed description will not be repeated.

A recording medium is not limited to a CD-ROM, a flexible disk (FD), or hard disk drive 540, but may be a medium that carries a program in a fixed manner such as a magnetic tape, a cassette tape, an optical disc (a magnetic optical disc (MO)/a mini disc (MD)/a digital versatile disc (DVD)), an integrated circuit (IC) card (including a memory card), an optical card, or a semiconductor memory such as a mask ROM, an electronically programmable read-only memory (EPROM), an electronically erasable programmable read-only memory (EEPROM), a flash ROM, or a secure socket disc (SSD).

The program herein encompasses not only a program directly executable by CPU 510 but also a program in a source program form, a compressed program, an encrypted program, and the like.

### [Effect of First Embodiment]

The inventors have found that the number of pieces of training data necessary for diagnosis without erroneous determination is different for each parameter configuring the trained model. Furthermore, the inventors have found that diagnosis can be conducted without erroneous determination even with a trained model created from some of a plurality of parameter values configuring the trained model which were obtained from a value of an identical parameter obtained from a data group different in operation state, that is, the trained model can be created by diverting some of parameter values between different operation states. In addition, it has been found that, since the parameter value obtained from training data in another operation state, the parameter value of which has already been calculated and held, can be diverted as the parameter that requires a relatively large number of pieces of training data (requiring time for collection of data), data necessary for calculation of the parameter value in the operation state does not have to be collected.

Then, with such a configuration as described in the first embodiment that processing for calculating and holding the parameter value in accordance with the result of sufficiency assessment of training data is performed for each parameter, and if some of parameter values in the operation state the same as diagnosis target data are not held (the number of pieces of training data is not sufficient), the parameter value of the identical parameter in another operation state is diverted to create the trained model and diagnosis is conducted, even when there is normal change in operation state, diagnosis without erroneous determination can be conducted with the minimum number of pieces of training data, that is, in a training data collection period shorter than in the conventional example. Since the trained model is created from the parameter value for which sufficiency assessment of training data is OK, one value can be determined as the threshold value for abnormality determination, calculation processing for determining the threshold value for abnormality determination does not have to be performed for each piece of diagnosis target data, and the amount of calculation can be reduced.

Furthermore, with such a configuration that, when none of parameter values configuring the trained model is calculated (the trained model that allows diagnosis without erroneous determination cannot be created) as a result of sufficiency assessment, the trained model is not created and diagnosis is postponed, erroneous determination can be reduced.

### Second Embodiment

A second embodiment will be described below. An abnormality diagnosis apparatus according to the second embodiment is different from abnormality diagnosis apparatus 100 according to the first embodiment in that abnormality diagnosis apparatus 100 according to the first embodiment performs a series of diagnosis processes including classification of data, calculation and holding of a parameter, obtainment of the parameter, creation of a trained model, calculation of a degree of abnormality, and determination with training data for any period being set in advance, whereas the abnormality diagnosis apparatus according to the second embodiment conducts diagnosis for a long period so that the parameter value held in each operation state is updated and diagnosis is conducted when additional training data can be obtained.

A main functional configuration and a hardware configuration of the abnormality diagnosis apparatus according to the second embodiment are the same as the main functional configuration and the hardware configuration of abnormality diagnosis apparatus 100 according to the first embodiment. Therefore, description thereof will not be repeated. Description of the second embodiment will be given with reference to the configuration of abnormality diagnosis apparatus 100 according to the first embodiment as appropriate.

Data classifier 104 according to the second embodiment classifies for each operation state, additional training data at a time point when the additional training data is available. The classification method can be performed as in the first embodiment.

Parameter calculator and holder 105 makes sufficiency assessment of classified data by using a classified data group. At this time, parameter calculator and holder 105 may make sufficiency assessment only based on the additional training data, or may make sufficiency assessment of a data group obtained by combining training data that has already been used for calculating and holding the parameter and the additional training data or a data group obtained by selecting some from this data group.

Parameter calculator and holder 105 calculates a parameter value to be held (or makes setting as “absence of value”) based on a result of data sufficiency assessment of each parameter, and overwrites the parameter value held in each operation state for use in current creation of the trained model with these values. The number of pieces of data used for calculation of the parameter value may be similar to the number of pieces of data used for sufficiency assessment.

Parameter calculator and holder 105 can use as the additional training data, data newly obtained from the facility or data determined as being normal in abnormality determination unit 109.

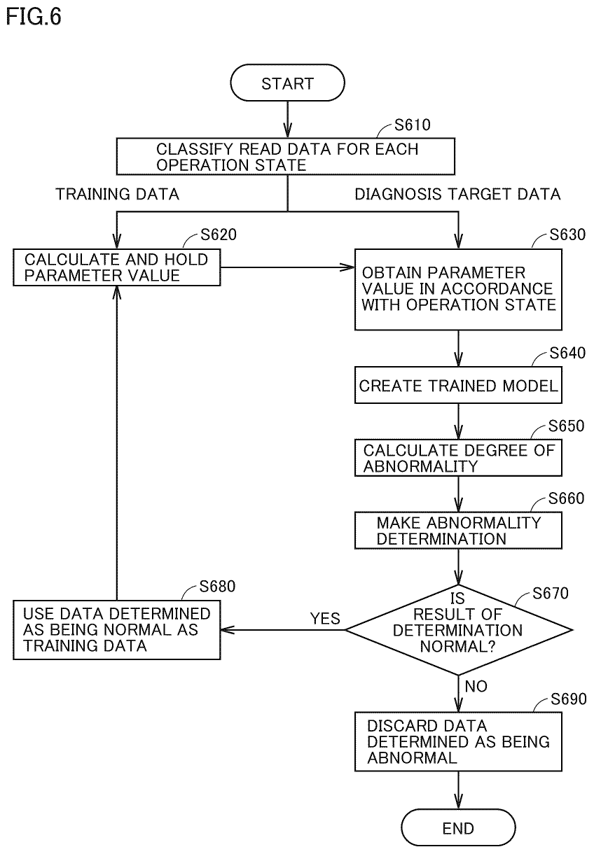

A control structure of abnormality diagnosis apparatus 100 according to the second embodiment will now be described with reference to FIG. 6. FIG. 6 is a flowchart showing a part of processing performed by CPU 510 of computer system 500 implementing abnormality diagnosis apparatus 100 according to the second embodiment.

In step S610, CPU 510 classifies for each operation state, data received from the facility or the device to be diagnosed. This is processing performed in data classifier 104. Thereafter, a flow of training data for calculating and holding the parameter proceeds to S620 (parameter calculator and holder 105) and a flow of data to be diagnosed proceeds to S630 (parameter obtaining unit 106).

In step S620, CPU 510 as parameter calculator and holder 105 calculates the parameter value from the training data and holds the value. As in the first embodiment, CPU 510 makes a sufficiency assessment of each parameter of training data in all operation states, and calculates and holds the parameter value in association with each operation state, in accordance with a result of assessment. Alternatively, CPU 510 holds absence of the parameter value.

In step S630, CPU 510 as parameter obtaining unit 106 obtains the parameter value associated with the operation state the same as the operation state of the diagnosis target data. If only some of parameters are held as in the first embodiment, CPU 510 obtains remaining parameters from parameter values of the identical type in another operation state. When none of parameter values is held, none of the parameter values is obtained.

In step S640, CPU 510 as trained model creator 107 creates the trained model from each obtained parameter value. When CPU 510 obtains none of parameter values, it does not create the trained model and temporarily puts diagnosis of the diagnosis target data on hold.

In step S650, CPU 510 as abnormality degree calculator 108 calculates the degree of abnormality of the facility or the device based on the created trained model and the diagnosis target data.

In step S660, CPU 510 as abnormality determination unit 109 compares the calculated degree of abnormality and the threshold value set in advance for abnormality determination with each other and makes abnormality determination to diagnose a state of the facility or the device.

In step S670, when a result of abnormality determination in step S660 is normal (YES in step S670), CPU 510 switches control to step S680. When the result of abnormality determination in step S660 is abnormal (NO in step S670), CPU 510 switches control to step S690.

In step S680, CPU 510 uses the diagnosis target data determined as being normal as training data. Thereafter, control returns to step S620. In other words, data designated as the training data is subjected to sufficiency assessment or processing for calculating and holding the parameter in parameter calculator and holder 105.

In step S690, CPU 510 discards the diagnosis target data the result of diagnosis of which has been determined as being abnormal, and excludes the diagnosis target data from candidates for training data.

### [Effect of Second Embodiment]

As set forth above, abnormality diagnosis apparatus 100 according to the second embodiment periodically calculates a latest value of the parameter from a data group including latest data on the facility and updates a held value, and hence diagnosis on which a latest state of the facility is reflected can be conducted.

When the result of the sufficiency assessment of the training data indicates NG, none of parameter values configuring the trained model can be calculated or obtained, and diagnosis is temporarily put on hold as exemplified in the first embodiment, abnormality diagnosis apparatus 100 according to the second embodiment performs the function above to make the sufficiency assessment when it obtains additional training data, and when the result of assessment indicates OK, it can calculate and hold all parameter values or some of the parameter values. Then, at the time point when the parameter value associated with the operation state the same as diagnosis target data is obtained, the trained model that allows diagnosis without erroneous determination can be created, and accuracy in diagnosis can be secured, diagnosis put on hold can be resumed. By thus conducting diagnosis of the facility over a long time period, data for training is supplemented, and diagnosis without erroneous determination of diagnosis target data in various operation states can be conducted. Since diagnosis can be resumed at the time point when at least some parameter values that require a relatively small number of pieces of training data can be calculated as in the first embodiment, a period of collection of training data can be minimized while accuracy in diagnosis is kept.

### Third Embodiment

Abnormality diagnosis according to a third embodiment will now be described. A hardware configuration of an abnormality diagnosis apparatus according to the third embodiment is the same as the hardware configuration of abnormality diagnosis apparatus 100 according to the first or second embodiment. Functions and a control structure other than functions and a control structure specific to the abnormality diagnosis apparatus according to the third embodiment are the same as the functions and the control structure of abnormality diagnosis apparatus 100 according to the first or second embodiment. Therefore, description of the same hardware configuration, functions, and control structure will not be repeated. Abnormality diagnosis apparatus 100 according to the third embodiment will be described below with reference to the hardware configuration, the functions, and the control structure of abnormality diagnosis apparatus 100 according to the first or second embodiment.

Abnormality diagnosis apparatus 100 according to the first and second embodiments conducts abnormality diagnosis when the operation state into which diagnosis target data is classified falls under any operation state determined in advance in classification of training data into the operation state. In another aspect, in determination in data classifier 104, of the operation state of the diagnosis target data, the operation state of the diagnosis target data may fall under none of the operation states determined in advance in classification of the training data into the operation state. The abnormality diagnosis apparatus according to the third embodiment is different from abnormality diagnosis apparatus 100 according to the first or second embodiment in that it conducts abnormality diagnosis also in such a case.

Initially, under which class of the operation state of the training data the operation state of the diagnosis target data falls is determined based on each classification approach and a determination threshold value in data classifier 104 shown in the first embodiment. An example where classification into the operation state is made based on the classification rules determined in the cluster processing will be described by way of example. Data classifier 104 calculates the center of gravity of each cluster from data belonging to each cluster determined in the cluster processing and obtains a distance between the center of gravity of each cluster and classification target data. When there is no such cluster that a distance between the center of gravity of each cluster and classification target data is equal to or shorter than a predetermined determination threshold value in comparison between this distance between the center of gravity of each cluster and the classification target data and the threshold value for determination as to classification into each predetermined cluster, data classifier 104 determines that the operation state of the diagnosis target data falls under none of the operation states determined in advance in classification of the training data into the operation state. As in a method of classification into the operation state based on processing for determining whether or not there is change in time-series data on at least one assessment item, similarly, when none of conditions (including the assessment item or the statistic thereof and the threshold value for determination) for classification into each operation state is satisfied, data classifier 104 determines that the operation state of the diagnosis target data falls under none of the operation states determined in advance in classification of the training data into the operation state.

An abnormality diagnosis processing method according to the third embodiment may be selected from two methods below, in accordance with operation characteristics of the facility or the device to be diagnosed. In a first method, when the operation state of the diagnosis target data falls under none of classes of the operation state of the training data, abnormality diagnosis apparatus 100 according to the third embodiment does not perform subsequent processing and determines the diagnosis target data as being abnormal. This first method is effective when the facility or the device to be diagnosed operates only in some operation states determined in advance.

In a second method, even when the operation state of the diagnosis target data falls under none of the operation states determined in advance in classification of the training data into the operation state, abnormality diagnosis apparatus 100 according to the third embodiment adds the operation state of the diagnosis target data as the operation state on which a series of abnormality diagnosis processes is to be performed. In other words, with the use of the diagnosis target data and data determined as being in the operation state the same as the diagnosis target data as the training data, parameter calculator and holder 105 makes the sufficiency assessment and performs processing for calculating and holding the parameter value. Furthermore, with the data determined as being in the operation state the same as the diagnosis target data being defined as the diagnosis target data, abnormality diagnosis apparatus 100 performs processing for obtaining the parameter value in parameter obtaining unit 106, processing for creating the trained model in trained model creator 107, processing for calculating the degree of abnormality in abnormality degree calculator 108, and processing for determining abnormality in abnormality determination unit 109. This second method is effective when prediction of the number of operation states that the facility to be diagnosed can be in or prediction of that state for determination of the optimal operation state each time in accordance with a peripheral device or an environment for operations cannot be made.

In the second method, when the operation state of the diagnosis target data falls under none of the operation states determined in advance in classification of the training data into the operation state, that is, falls under none of the operation states to be subjected to processing in parameter calculator and holder 105, data classifier 104 inputs the diagnosis target data as the training data to parameter calculator and holder 105. Parameter calculator and holder 105 calculates and holds the parameter value to be held in this operation state, with the operation state to which the diagnosis target data belongs being newly added as the operation state to be learnt.

Parameter calculator and holder 105 then performs processing as in the first embodiment onto inputted data. Specifically, parameter calculator and holder 105 conducts the sufficiency assessment of the number of pieces of data for a plurality of parameters configuring the trained model. When the sufficiency assessment is OK, parameter calculator and holder 105 calculates the parameter value of the parameter and holds the parameter value in association with the newly learnt operation state. When the sufficiency assessment is NG, parameter calculator and holder 105 holds the parameter value as absence of value. Parameter obtaining unit 106 then obtains the parameter value associated with the newly learnt operation state. When all of the plurality of parameters configuring the trained model can be obtained as in the first embodiment, the parameter obtaining unit obtains all parameter values. If some of the parameter values can be obtained, parameter obtaining unit 106 obtains some of the parameter values that can be obtained, and obtains remaining parameter values from parameter values of the identical type held in a different operation state. When all parameter values fall under absence of value, parameter obtaining unit 106 obtains none of parameter values. When the parameter value can thus be obtained with determination as presence of value being made, trained model creator 107 creates the trained model and abnormality degree calculator 108 and abnormality determination unit 109 each perform processing to determine whether or not there is abnormality. When none of parameter values can be obtained, trained model creator 107 does not create the trained model and abnormality diagnosis apparatus 100 temporarily puts diagnosis on hold.

A specific flow of operations in the processing so far will be shown. Parameter calculator and holder 105 newly collects data necessary for calculation of parameters in the newly added operation state. Therefore, in an initial stage of collection of the training data, the sufficiency assessment of all parameter values configuring the trained model is NG and parameter calculator and holder 105 does not calculate the parameter value. Therefore, trained model creator 107 does not create the trained model. With this processing, while the number of pieces of data inputted to parameter calculator and holder 105 is smaller than the number of pieces of data necessary for calculation of the parameter that allows diagnosis without erroneous determination, abnormality diagnosis apparatus 100 can temporarily put diagnosis on hold and avoid erroneous determination.

As time further elapses, the number of pieces of inputted training data increases. Then, the sufficiency assessment of the parameter that requires a smallest number of pieces of data for calculation of the parameter values is OK, and this parameter value is calculated. Then, at this stage, since parameter obtaining unit 106 and trained model creator 107 can obtain remaining parameter values from parameter values of the identical type calculated and held in a different operation state and create the trained model, abnormality diagnosis apparatus 100 can resume diagnosis. A parameter diverted from the different operation state requires a larger number of pieces of data than other parameters for diagnosis without erroneous determination, and it takes time for collection of data. According to the configuration of the present invention, a period that has been necessary for this collection of data in the conventional example can be reduced, and in a short data collection period in correspondence thereto, abnormality diagnosis apparatus 100 can conduct diagnosis without erroneous determination.

As set forth above, abnormality diagnosis apparatus 100 disclosed above can create the trained model without erroneous determination in the shortest data collection period and can conduct abnormality diagnosis even when prediction in advance of the number of operation states that the facility to be diagnosed can be in or prediction in advance of that state for determination of the optimal operation state each time in accordance with a peripheral device or an environment for operations cannot be made.

Furthermore, abnormality diagnosis apparatus 100 is configured such that parameter calculator and holder 105 conducts the sufficiency assessment of the number of pieces of data, and hence it does not have to calculate the threshold value for abnormality determination for each piece of diagnosis target data. Therefore, since an amount of computation by abnormality diagnosis apparatus 100 is reduced, increase in calculation resources can be suppressed.

Some of technical features disclosed above can be summarized as below.

[Configuration 1] According to one embodiment, an abnormality diagnosis method performed by a computer (for example, computer system 500) is provided.

This abnormality diagnosis method includes obtaining, by CPU 510 as data reader 102, obtaining data having a quantity of state of a single assessment item or a plurality of assessment items from a diagnosis target through communication interface 550, classifying, by CPU 510 as data classifier 104, the data having the quantity of state of the single assessment item or the plurality of assessment items for each operation state of the facility or the device to be diagnosed, assessing, by CPU 510 as parameter calculator and holder 105, sufficiency of the number of pieces of data for each classified data group, calculating (deriving), by CPU 510 as parameter calculator and holder 105, a plurality of parameter values configuring a trained model in accordance with the sufficiency of the number of pieces of data and holding these parameter values in association with the operation state, obtaining, by CPU 510 as parameter obtaining unit 106, the plurality of parameter values configuring the trained model without overlaps for each parameter, in accordance with the operation state of diagnosis target data and a status of holding of the parameter values associated with each operation state, creating, by CPU 510 as trained model creator 107, a trained model with the obtained parameter values, calculating, by CPU 510 as abnormality degree calculator 108, a degree of abnormality for determination as to abnormality based on the trained model, and determining, by CPU 510 as abnormality determination unit 109, whether there is abnormality in a diagnosis target based on the calculated degree of abnormality.

According to the configuration above, a plurality of parameter values configuring the trained model are obtained without overlaps for each parameter, in accordance with the operation state of data to be diagnosed and the status of holding of the parameter values associated with each operation state,. The trained model is created with the obtained parameter values. The degree of abnormality for making determination as to abnormality based on the created trained model is calculated, and whether or not there is abnormality in a diagnosis target is determined based on the calculated degree of abnormality. Thus, normal change in operation state due to maintenance or change in operation mode is not erroneously determined as abnormality but accuracy in diagnosis can be improved. Furthermore, even when change in operation state of the facility is not predictable in advance, a period for newly collecting training data necessary for diagnosis can be reduced. In addition, an amount of calculation necessary for such calculation processing can be reduced.

[Configuration 2] In addition to the configuration above, in the abnormality diagnosis method according to one aspect, the classifying the data having the quantity of state of the single assessment item or the plurality of assessment items for each operation state of the facility includes performing the classifying based on cluster processing or processing for determining whether there is change in the data as to at least one assessment item.

[Configuration 3] In addition to the configuration above, in the abnormality diagnosis method according to one aspect, the determining whether there is change in the data includes determining whether there is change, with at least one of an average, a variance, a standard deviation, a maximum, a minimum, a kurtosis, and a skewness calculated from any temporal range of the data being used as a determination index.

[Configuration 4] In addition to the configuration above, in the abnormality diagnosis method according to one aspect, the assessing sufficiency of the number of pieces of data includes performing the assessing with at least one of a method of determining in advance, the number of pieces of data that can be diagnosed without erroneous determination from past records of diagnosis and making an assessment based on this number of pieces of data, or a method of making an assessment based on a coefficient of correlation among any assessment items calculated from any temporal range of each data group or an amount of change in basic statistic of any assessment item.

[Configuration 5] In addition to the configuration above, in the abnormality diagnosis method according to one aspect, the obtaining the plurality of parameter values configuring the trained model without overlaps for each parameter, in accordance with the operation state of diagnosis target data and a status of holding of the parameter values associated with each operation state includes obtaining all parameter values configuring the trained model based on a fact that the all parameter values are held in an operation state identical to the operation state of the data to be diagnosed and obtaining, based on a fact that only some of parameter values configuring the trained model are held in the operation state identical to the operation state of the data to be diagnosed, only some of the parameter values and obtaining remaining parameter values from parameter values of an identical type held in another operation state.

[Configuration 6] In addition to the configuration above, in the abnormality diagnosis method according to one aspect, the calculating a plurality of parameter values configuring a trained model in accordance with the sufficiency of the number of pieces of data and holding the parameter values in association with the operation state includes periodically calculating a latest value of a parameter from a data group including latest data obtained from the facility and updating the held parameter values. Being periodic refers to a time interval set in advance and refers, for example, to time in one day designated in advance, specific time every week, a certain time and date in each month, or the like.

[Configuration 7] In addition to the configuration above, in the abnormality diagnosis method according to one aspect, the trained model is a unit space according to a Mahalanobis-Taguchi method. The plurality of parameter values are an average, a standard deviation, and an inverse matrix of a correlation matrix of data defining the unit space.

[Configuration 8] In addition to the configuration above, the abnormality diagnosis method according to one aspect further includes outputting, by CPU 510 as determination result output unit 110, outputting a result of determination as to the diagnosis target. A destination of output is a monitor apparatus or another display unit 580 or a server computer or another information management apparatus connected to a communication interface and remotely arranged.

[Configuration 9] According to another embodiment, abnormality diagnosis apparatus 100 (or computer system 500) to diagnose whether there is abnormality in a diagnosis target is provided. This abnormality diagnosis apparatus 100 includes a memory (for example, EOM 520, RAM 530, or HDD 540) where a program is stored and a processor (for example, CPU 510) coupled to the memory to execute the program. The program causes the processor to perform obtaining from the diagnosis target, data having a quantity of state of a single assessment item or a plurality of assessment items, classifying for each operation state of the diagnosis target, the data having the quantity of state of the single assessment item or the plurality of assessment items, assessing sufficiency of the number of pieces of data for each classified data group, calculating (deriving) a plurality of parameter values configuring a trained model in accordance with the sufficiency of the number of pieces of data and holding these parameter values in association with the operation state, obtaining the plurality of parameter values configuring the trained model without overlaps for each parameter, in accordance with the operation state of diagnosis target data and a status of holding of the parameter values associated with each operation state, creating a trained model with the obtained parameter values, calculating a degree of abnormality for determination as to abnormality based on the trained model, and determining whether there is abnormality in the diagnosis target based on the degree of abnormality.

[Configuration 10] In addition to the configuration above, in the abnormality diagnosis apparatus according to one aspect, the program causes the processor to further perform outputting a result of determination of the diagnosis target.

[Configuration 11] According to yet another embodiment, an abnormality diagnosis program to diagnose whether there is abnormality in a diagnosis target is provided. This abnormality diagnosis program causes a processor (for example, CPU 510) to perform obtaining from the diagnosis target, data having a quantity of state of a single assessment item or a plurality of assessment items, classifying for each operation state of the diagnosis target, the data having the quantity of state of the single assessment item or the plurality of assessment items, assessing sufficiency of the number of pieces of data for each classified data group, calculating (deriving) a plurality of parameter values configuring a trained model in accordance with the sufficiency of the number of pieces of data and holding these parameter values in association with the operation state, obtaining the plurality of parameter values configuring the trained model without overlaps for each parameter, in accordance with the operation state of the diagnosis target data and a status of holding of the parameter values associated with each operation state, creating a trained model with the obtained parameter values, calculating a degree of abnormality for determination as to abnormality based on the trained model, and determining whether there is abnormality in the diagnosis target based on the degree of abnormality.

[Configuration 12] In addition to the configuration above, the abnormality diagnosis program according to one aspect causes the processor to further perform outputting a result of determination of the diagnosis target.

[Configuration 13] According to yet another embodiment, an abnormality diagnosis system to diagnose whether or not there is abnormality in a diagnosis target is provided. This abnormality diagnosis system causes a processor (for example, CPU 510) to perform obtaining from the diagnosis target, data having a quantity of state of a single assessment item or a plurality of assessment items, classifying for each operation state of the diagnosis target, the data having the quantity of state of the single assessment item or the plurality of assessment items, assessing sufficiency of the number of pieces of data for each classified data group, calculating (deriving) a plurality of parameter values configuring a trained model in accordance with the sufficiency of the number of pieces of data and holding these parameter values in association with the operation state, obtaining the plurality of parameter values configuring the trained model without overlaps for each parameter, in accordance with the operation state of the diagnosis target data and a status of holding of the parameter values associated with each operation state, creating a trained model with the obtained parameter values, calculating a degree of abnormality for determination as to abnormality based on the trained model, and determining whether there is abnormality in the diagnosis target based on the degree of abnormality.

[Configuration 14] In addition to the configuration above, the abnormality diagnosis system according to one aspect causes the processor to further perform outputting a result of determination of the diagnosis target.

It should be understood that the embodiments disclosed herein are illustrative and non-restrictive in every respect. The scope of the present invention is defined by the terms of the claims rather than the description above and is intended to include any modifications within the scope and meaning equivalent to the terms of the claims.

### Reference Signs List

10 facility or device; 100 abnormality diagnosis apparatus; 102 data reader; 103 data display unit; 104 data classifier; 105 parameter calculator and holder; 106 parameter obtaining unit; 107 trained model creator; 108 abnormality degree calculator; 109 abnormality determination unit; 110 determination result output unit; 500 computer system; 510 CPU; 520 ROM; 530 RAM; 540 hard disk drive; 550 communication interface; 560 input and output interface; 570 input unit; 580 display unit.

1. An abnormality diagnosis method of diagnosing whether there is abnormality in a facility to be diagnosed, the abnormality diagnosis method comprising:
obtaining from the facility, data having a quantity of state of a single assessment item or a plurality of assessment items;
classifying for each operation state of the facility, the data obtained from the facility;
assessing sufficiency of the number of pieces of data for each classified data group;
calculating a plurality of parameter values configuring a trained model in accordance with the sufficiency of the number of pieces of data and holding the parameter values in association with the operation state;
obtaining the plurality of parameter values configuring the trained model without overlaps for each parameter, in accordance with the operation state of the data to be diagnosed and a status of holding of the parameter values associated with each operation state;
creating a trained model to diagnose data to be diagnosed, with the obtained parameter values;
calculating a degree of abnormality for determination as to abnormality based on the trained model; and p1 determining whether there is abnormality in a diagnosis target based on the degree of abnormality, wherein the obtaining the plurality of parameter values configuring the trained model without overlaps for each parameter, in accordance with the operation state of the data to be diagnosed and a status of holding of the parameter values associated with each operation state comprises:
obtaining all parameter values configuring the trained model based on a fact that the all parameter values are held in an operation state identical to the operation state of data to be diagnosed; and
obtaining, based on a fact that only some of parameter values configuring the trained model is held in the operation state identical to the operation state of the data to be diagnosed, only some of the parameter values and obtaining remaining parameter values from parameter values of an identical type held in another operation state.

2. The abnormality diagnosis method according to claim 1, wherein p1 the classifying the data for each operation state of the facility comprises performing the classifying based on cluster processing or processing for determining whether there is change in the data as to at least one assessment item.

3. The abnormality diagnosis method according to claim 2, wherein the determining whether there is change in the data comprises determining whether there is change, with at least one of an average, a variance, a standard deviation, a maximum, a minimum, a kurtosis, and a skewness calculated from any temporal range of the data being used as a determination index.

4. The abnormality diagnosis method according to claim 1, wherein the assessing sufficiency of the number of pieces of data comprises performing the assessing with at least one of:
a method of determining in advance, the number of pieces of data that can be diagnosed without erroneous determination from past records of diagnosis and making an assessment based on the number of pieces of data; or p1 a method of making an assessment based on a coefficient of correlation among any assessment items calculated from any temporal range of each data group or an amount of change in basic statistic of any assessment item.

5. (canceled)

6. The abnormality diagnosis method according to claim 1, wherein the calculating a plurality of parameter values configuring a trained model in accordance with the sufficiency of the number of pieces of data and holding the parameter values in association with the operation state comprises periodically calculating a latest value of a parameter from a data group including latest data obtained from the facility and updating the held parameter values.

7. The abnormality diagnosis method according to claim 1, wherein the trained model is a unit space according to a Mahalanobis-Taguchi method, and the plurality of parameter values are an average, a standard deviation, and an inverse matrix of a correlation matrix of data defining the unit space.

8. An abnormality diagnosis apparatus to diagnose whether there is abnormality in a facility to be diagnosed, the abnormality diagnosis apparatus comprising:
a data reader to obtain from the facility, data having a quantity of state of a single assessment item or a plurality of assessment items;
a data classifier to classify for each operation state of the facility, the data obtained from the facility;
a parameter calculator and holder to assess sufficiency of the number of pieces of data for each classified data group, to calculate a plurality of parameter values configuring a trained model in accordance with the sufficiency of the number of pieces of data, and to hold the parameter values in association with the operation state;
a parameter obtaining unit to obtain the plurality of parameter values configuring the trained model without overlaps for each parameter, in accordance with the operation state of the data to be diagnosed and a status of holding of the parameter values associated with each operation state;
a trained model creator to create a trained model to diagnose the data to be diagnosed, with the obtained parameter values;
an abnormality degree calculator to calculate a degree of abnormality for determination as to abnormality based on the trained model; and p1 an abnormality determination unit to determine, based on the degree of abnormality, whether there is abnormality in a diagnosis target, wherein:
the parameter obtaining unit obtains all parameter values configuring the trained model based on a fact that the all parameter values are held in an operation state identical to the operation state of data to be diagnosed; and
the parameter obtaining unit obtains, based on a fact that only some of parameter values configuring the trained model is held in the operation state identical to the operation state of the data to be diagnosed, only some of the parameter values and obtaining remaining parameter values from parameter values of an identical type held in another operation state.

9. A non-transitory computer-readable medium storing abnormality diagnosis program to cause a computer to perform processing for diagnosing whether there is abnormality in a facility to be diagnosed, the abnormality diagnosis program causing the computer to perform:
obtaining from the facility, data having a quantity of state of a single assessment item or a plurality of assessment items;
classifying for each operation state of the facility, the data obtained from the facility;
assessing sufficiency of the number of pieces of data for each classified data group;
calculating a plurality of parameter values configuring a trained model in accordance with the sufficiency of the number of pieces of data and holding the parameter values in association with the operation state;
obtaining the plurality of parameter values configuring the trained model without overlaps for each parameter, in accordance with the operation state of the data to be diagnosed and a status of holding of the parameter values associated with each operation state;
creating a trained model to diagnose the data to be diagnosed, with the obtained parameter values;
calculating a degree of abnormality for determination as to abnormality based on the trained model; and p1 determining whether there is abnormality in a diagnosis target based on the degree of abnormality, p1 wherein the obtaining the plurality of parameter values configuring the trained model without overlaps for each parameter, in accordance with the operation state of the data to be diagnosed and a status of holding of the parameter values associated with each operation state comprises:
obtaining all parameter values configuring the trained model based on a fact that the all parameter values are held in an operation state identical to the operation state of data to be diagnosed; and
obtaining, based on a fact that only some of parameter values configuring the trained model is held in the operation state identical to the operation state of the data to be diagnosed, only some of the parameter values and obtaining remaining parameter values from parameter values of an identical type held in another operation state.

10. An abnormality diagnosis system to diagnose whether there is abnormality in a facility to be diagnosed, comprising:
a data reader to obtain from the facility, data having a quantity of state of a single assessment item or a plurality of assessment items;
a data classifier to classify for each operation state of the facility, the data obtained from the facility;
a parameter calculator and holder to assess sufficiency of the number of pieces of data for each classified data group, to calculate a plurality of parameter values configuring a trained model in accordance with the sufficiency of the number of pieces of data, and to hold the parameter values in association with the operation state;
a parameter obtaining unit to obtain the plurality of parameter values configuring the trained model without overlaps for each parameter, in accordance with the operation state of the data to be diagnosed and a status of holding of the parameter values associated with each operation state;
a trained model creator to create a trained model to diagnose the data to be diagnosed, with the obtained parameter values;
an abnormality degree calculator to calculate a degree of abnormality for determination as to abnormality based on the trained model; and p1 an abnormality determination unit to determine whether there is abnormality in a diagnosis target based on the degree of abnormality, p1 wherein the obtaining the plurality of parameter values configuring the trained model without overlaps for each parameter, in accordance with the operation state of the data to be diagnosed and a status of holding of the parameter values associated with each operation state comprises:
obtaining all parameter values configuring the trained model based on a fact that the all parameter values are held in an operation state identical to the operation state of data to be diagnosed; and
obtaining, based on a fact that only some of parameter values configuring the trained model is held in the operation state identical to the operation state of the data to be diagnosed, only some of the parameter values and obtaining remaining parameter values from parameter values of an identical type held in another operation state.
